(19) United States
(12) Patent Application Publication
(10) Pub. No.: US 2007/0165269 A1
(43) Pub. Date: Jul. 19, 2007

(54) Communication Terminal Device, Communication Method, and Communication System

(75) Inventor: Osamu KIMOTO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/565,413

(22) Filed: Nov. 30, 2006

(30) Foreign Application Priority Data
Jan. 17, 2006 (JP) 2006-008961

(51) Int. Cl. G06F 3/12

(52) U.S. Cl. 358/1.15; 358/400

(57) ABSTRACT

A recipient communication terminal device, that can communicate in a V.34 communication mode, communicates with a transmitter communication terminal device, that cannot communicate in the V.34 communication mode. The transmitter device detects whether or not the recipient device includes V.8 communication mode capability in accordance with a received digital identification signal (DIS). When the transmitter device detects that the recipient device includes V.8 communication mode capability, the transmitter device generates a silent state for a prescribed period of time as a response to the received DIS, or stands by without responding to the received DIS until a second DIS is received.

### RELATED APPLICATIONS

This application claims priority under 35 USC 119 in Japanese patent application number 2006-008961, filed on Jan. 17, 2006, which is hereby incorporated by reference in its entirety.

### BACKGROUND OF THE INVENTION

1. Field of the Invention

The present invention relates to a communication terminal device, such as a facsimile machine, which carries out communication in accordance with a communication mode of the International Telecommunication Union (ITU) recommendation, and also relates to a communication method and a communication system for carrying out data communication between such communication terminal devices.

2. Description of the Related Art

A facsimile modem of a V.34 communication mode of the ITU recommendation, which is also known as the “super Group 3 (G3), has been put into a practical use as a facsimile modem for transmitting image data via a Public Switched Telephone Network (PSTN). Such a facsimile modem is capable of carrying out communication at a higher speed (maximum data rate: 33.6 kbs) than a conventional facsimile modem. Facsimile communication is carried out using an Internet Protocol (IP) network, which is a communication network using an IP communication procedure.

When starting a communication according to the V.8 and the V.34 communication modes, after a connection is established with a communication line, first, a recipient communication terminal device transmits an ANSam signal to a transmitter communication terminal device. Then, by exchanging a Common Mode (CM) signal and a Joint Menu (JM) signal, the communication terminal device recognizes that the communication terminal device of the other end is a facsimile machine. In this case, the communication is identified as a facsimile communication according to the V.8 protocol. Then, it proceeds onto the V.34 protocol, and the facsimile communication starts between the communication terminal devices.

Several proposals have been made regarding V.8 and V.34 communication mode technology. According to one proposal, even when the recipient communication terminal device transmits an ANSam signal to the transmitter communication terminal device, when the recipient communication terminal device does not receive the CM signal, the recipient communication terminal device transmits a Digital Identification Signal (DIS). Then, when the recipient communication terminal device receives a Call Identification (CI) signal from the transmitter communication terminal device, the recipient communication terminal device transmits the ANSam signal again. According to another proposal, a communication terminal device including a V.34 communication mode function efficiently carries out a polling communication. According to another proposal, communication by the V.34 communication mode is carried out smoothly via the IP network.

Suppose that the transmitter communication terminal device is a communication terminal device incapable of executing communication in the V.34 communication mode (hereinafter referred to as a “non V.34 terminal”), and the recipient communication terminal device is a communication terminal device capable of executing communication in the V.34 communication mode (hereinafter also referred to as a “V.34 terminal”). In this situation, an echo canceller, which is one of the network controls in facsimile communication using the IP network, does not operate as intended and causes a communication error for the reasons discussed below.

In a communication system including a non V.34 terminal as the transmitter and a V.34 terminal as the recipient, first, the recipient V.34 terminal transmits an ANSam signal (a phase inversion signal of 2100 Hz). The echo canceller of the IP network detects a phase inversion of 2100 Hz in the ANSam signal, and the echo canceller is turned OFF. Although the echo canceller is turned OFF, the transmitter non V.34 terminal cannot detect the ANSam signal.

According to the ITU recommendation, when not responding to the ANSam signal, the procedure is to fall back to a prescribed communication mode. In the case of facsimile communication, the terminal proceeds onto a protocol of the non V.34 communication mode. As a result, the recipient V.34 terminal becomes capable of transmitting a DIS of the V.21 communication mode. Meanwhile, although the transmitter non V.34 terminal cannot detect the ANSam signal, the transmitter non V.34 terminal can detect a subsequent DIS. Therefore, the transmitter non V.34 terminal transmits a Digital Command Signal (DCS), which is a response to the DIS, and the facsimile communication protocol proceeds.

However, in such a case, since the echo canceller is turned OFF, the communication at the transmitter non V.34 terminal is influenced by echo. As a result, communication errors are frequently generated.

### SUMMARY OF THE INVENTION

In order to overcome the problems described above, the present invention provides a communication terminal device, such as a facsimile machine, that prevents a communication error resulting from an echo canceller not operating as intended. The present invention also provides a communication system in which data communication is carried out between communication terminal devices.

According to a first aspect of the present invention, a communication terminal device detects a presence or an absence of a capability of an ITU recommendation V.8 communication mode according to a received DIS. When the presence of the capability of the V.8 communication mode is detected, the communication terminal device generates a silent state for a prescribed period of time as a response to the received DIS.

According to the first aspect, when the presence of V.8 communication mode capability of a communication terminal device of the other end is detected, the silent state is generated for a prescribed period of time (at least 400 ms). As a result of the silent state, the echo canceller returns to the ON state from the OFF state, and the communication terminal device of the other end operates as intended by a user. The communication terminal device is not influenced by an echo, and a communication error is not generated.

According to a second aspect of the present invention, until responding to the received DIS, the communication terminal device sets a silent time lasting for the prescribed period of time.

According to the second aspect, when the communication terminal device receives the DIS, the communication terminal device responds after standing by for a prescribed period of time (at least 400 ms). As a result, the silent state is generated easily for the prescribed period of time (at least 400 ms).

According to a third aspect of the present invention, the communication terminal device stands by until receiving a next DIS, without responding to the already received DIS.

According to the third aspect, the silent state is generated easily for the prescribed period of time (at least 400 ms).

According to a fourth aspect of the present invention, the communication terminal device is incapable of executing a communication function of the V.34 communication mode of the ITU recommendation.

According to the fourth aspect, even when a transmitter communication terminal device is a non V.34 terminal, the echo canceller operates as intended by the user. The communication terminal device is not influenced by the echo, and a communication error is not generated.

According to a fifth aspect of the present invention, the communication terminal device carries out a facsimile communication via an IP network.

According to the fifth aspect, a communication error is not generated in the facsimile communication via the IP network.

According to a sixth aspect of the present invention, when carrying out communication between a transmitter communication terminal device, which is incapable of executing a communication of the V.34 communication mode of the ITU recommendation, and a recipient communication terminal device, which is capable of executing a communication of the V.34 communication mode, the transmitter communication device detects a presence or an absence of V.8 communication mode capability in accordance with a received DIS. When V.8 communication mode capability is detected, a silent state is generated for a prescribed period of time as a response to the received DIS.

According to the sixth aspect, in a communication system including a non V.34 terminal as a transmitter and a V.34 terminal as a recipient, when the transmitter non V.34 terminal determines that the recipient communication terminal device includes V.8 communication mode capability, the silent state is generated for a prescribed period of time (at least 400 ms). As a result of the silent state, the echo canceller returns to the ON state from the OFF state, and the communication of the non V.34 terminal as the transmitter is not influenced by echo. As a result, a communication error is not generated.

When V.8 communication mode capability in the communication terminal device of the other end is detected, the silent state is generated for a prescribed period of time (at least 400 ms). Therefore, the echo canceller, which has been turned OFF by an ANSam signal, can be returned to the original ON state. As a result, communication errors resulting from the echo canceller not operating as intended are prevented.

Other features, elements, processes, steps, characteristics and advantages of the invention will become more apparent from the following detailed description of embodiments of the invention with reference to the attached drawings.

### BRIEF DESCRIPTION OF THE DRAWINGS

FIG. 1 is a block diagram illustrating a configuration of a facsimile machine according to an embodiment of the present invention.

FIG. 2 is a flowchart illustrating a procedure by which the facsimile machine transmits image data according to an embodiment of the present invention.

FIG. 3 is a flowchart illustrating a procedure by which the facsimile machine transmits image data according to an embodiment of the present invention.

### DETAILED DESCRIPTION OF PREFERRED EMBODIMENTS

Embodiments of the present invention are now described with reference to the drawings. The invention is not limited to the embodiments described hereinafter.

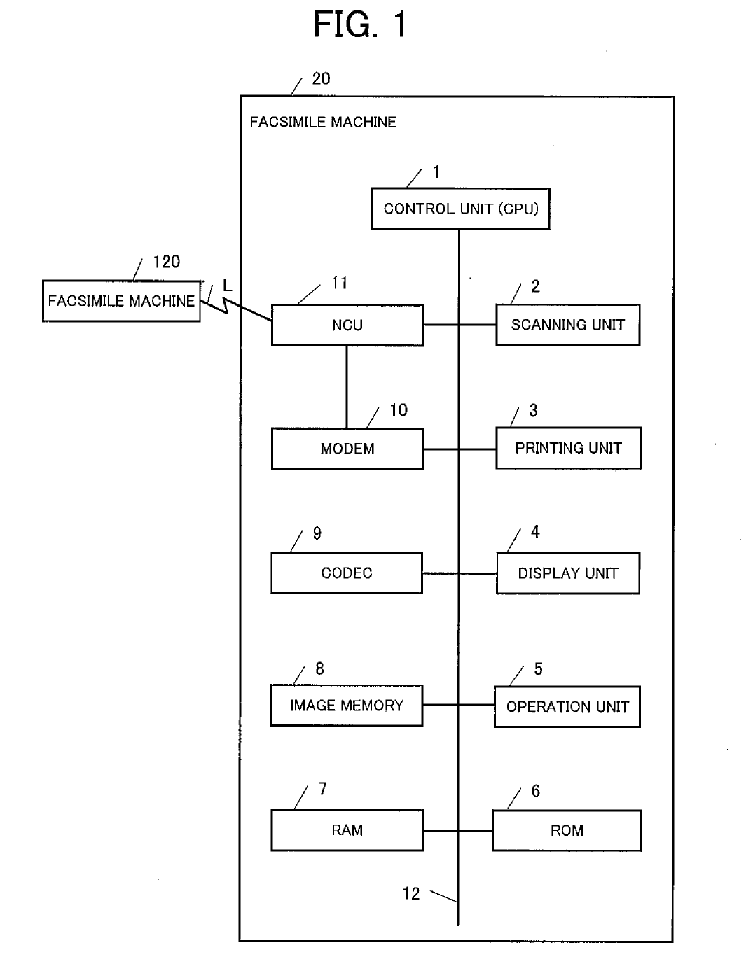

FIG. 1 is a block diagram illustrating a configuration of a facsimile machine as a communication terminal device according to an embodiment of the present invention. A facsimile machine 20 includes a control unit 1, a scanning unit 2, a printing unit 3, a display unit 4, an operation unit 5, a Read Only Memory (ROM) 6, a Random Access Memory (RAM) 7, an image memory 9, a Coder and Decoder (CODEC) 9, a Modulator and Demodulator (MODEM) 10, and a Network Control Unit (NCU) 11.

The control unit 1 includes a Central Processing Unit (CPU). The control unit 1 is connected to each of the abovementioned hardware components of the facsimile machine 20 via a bus 12. The control unit 1 controls each of the hardware components, and executes various software functions in accordance with a control program stored in the ROM 6. The control unit 1 includes a timer (not illustrated) for clocking various prescribed period of times described hereinafter. The control unit 1 executes processes described hereinafter to detect a presence or an absence of a capability of the V.8 communication mode in accordance with a received DIS and to generate a silent state for a prescribed period of time.

The scanning unit 2 scans an original document by an optical system using a Charge Coupled Device (CCD) or the like, and outputs scanned image data. The printing unit 3 is an electrophotographic printer. The printing unit 3 prints out an image onto printing paper according to the image data of the original document scanned by the scanner unit 2, and image data received by facsimile communication, or the like.

The display unit 4 is a display device such as a Liquid Crystal Display (LCD) or a Cathode-Ray Tube (CRT) display. The display unit 4 displays an operation status of the facsimile machine 20, and displays a screen for urging a user to perform an input operation and a screen for displaying a warning to the user. The operation unit 5 includes character keys, a ten-key numeric pad, speed dial keys, and various function keys or the like necessary for operating the facsimile machine 20. When the display unit 4 is a touch screen, a part or all of the various keys of the operation unit 5 may be substituted.

The ROM 6 stores various software programs necessary for operation of the facsimile machine 20. The RAM 7 stores temporary data that is generated when software is executed. The image memory 8 includes a dynamic RAM (DRAM), a synchronous DRAM (SDRAM), or the like. For example, the image memory 8 stores image data obtained by scanning an original document, and image data received from another facsimile machine. The CODEC 9 compresses image data to be transmitted by the facsimile machine 20 in accordance with a prescribed coding scheme, and expands image data received by the facsimile machine 20 in accordance with a prescribed coding scheme.

The MODEM 10 is connected to the bus 12, and is a facsimile modem capable of carrying out facsimile communication. The MODEM 10 is a facsimile modem of the non V.34 communication mode, and does not include a function of the V.34 communication mode. The MODEM 10 is directly connected to the NCU 11, which is also connected to the bus 12. The NCU 11 is hardware that carries out an operation for connecting and releasing a PSTN L. The NCU 11 connects the MODEM 10 to the PSTN L according to necessity.

FIG. 1 also illustrates another facsimile machine 120 connected to the PSTN L. The facsimile machine 120 includes a facsimile modem of the V.34 communication mode including a function of the V.34 communication mode.

In a communication system including the facsimile machine 20 and the facsimile machine 120, facsimile communication using an IP network is carried out. In case of carrying out facsimile communication using the IP network, for example, when the facsimile machine 20 (a transmitter communication terminal device) is connected to a public telephone network and the facsimile machine 120 (a recipient communication terminal device) is connected to a public telephone network, the facsimile machine 20 accesses the nearest IP network via a first gateway of the IP network. Then, the facsimile machine 20 establishes a connection with the facsimile machine 120 via a second gateway that is nearest to the facsimile machine 120. Between the facsimile machine 20 and the first gateway, and between the second gateway and the facsimile machine 120, communication is carried out by a call switching scheme. Between the first gateway and the second gateway, communication is carried out by a packet data exchange scheme.

After making a call, when receiving a DIS, the facsimile machine 20, which is a non V.34 terminal according to an embodiment of the present invention, detects a presence or an absence of a capability of the V.8 communication mode in accordance with the received DIS. Since the facsimile machine 20 is a non V.34 terminal, the facsimile machine 20 cannot detect an ANSam signal. However, the facsimile machine 20 can check each BIT of the DIS. Specifically, the facsimile machine 20 checks the No. 6 BIT of the received DIS, i.e., the BIT of V.8 capability. According to the check result, the facsimile machine 20 detects a presence or an absence of a capability of the V.8 communication mode. That is, when the BIT of the V.8 capability is “1”, the facsimile machine 20 determines that the recipient communication terminal device is a V.34 terminal. When the BIT is “0”, the facsimile machine 20 determines that the recipient communication terminal device is a non V.34 terminal.

When the facsimile machine 20 determines that the recipient communication terminal device has the capability of the V.8 communication mode, i.e., when the facsimile machine 20 determines that the recipient communication terminal device is a V.34 terminal, the facsimile machine 20 generates a silent state for a prescribed period of time (at least 400 ms) The present invention provides two modes (methods) for generating the silent state. According to a first mode, after standing by for a prescribed period of time (at least 400 ms) from the reception of the DIS, the facsimile machine 20 responds. According to a second mode, the facsimile machine 20 waits to receive a next DIS without responding to the first DIS. Either the first mode or the second mode may be selected by switching a setting.

An echo canceller of an IP network is standardized to return to an ON state when a silent state of approximately 400 ms is detected. Therefore, according to an embodiment of the invention, in order to return the echo canceller, which has been turned OFF by the ANSam signal, to the original ON state, the above-described silent state is generated for a prescribed period of time (at least 400 ms).

The echo canceller is turned OFF for once by the ANSam signal transmitted from a recipient V.34 terminal. However, after the silent state of the prescribed period of time (at least 400 ms), the echo canceller returns to the ON state. Accordingly, the echo canceller operates as intended by the user in the subsequent communication process, and the subsequent communication process is not influenced by echo. As a result, communication errors are not generated.

As described above, even when the transmitter communication terminal device is a non V.34 terminal, the transmitter communication terminal device correctly determines the capability of the recipient communication terminal device. As a result, unnecessary communication errors are prevented.

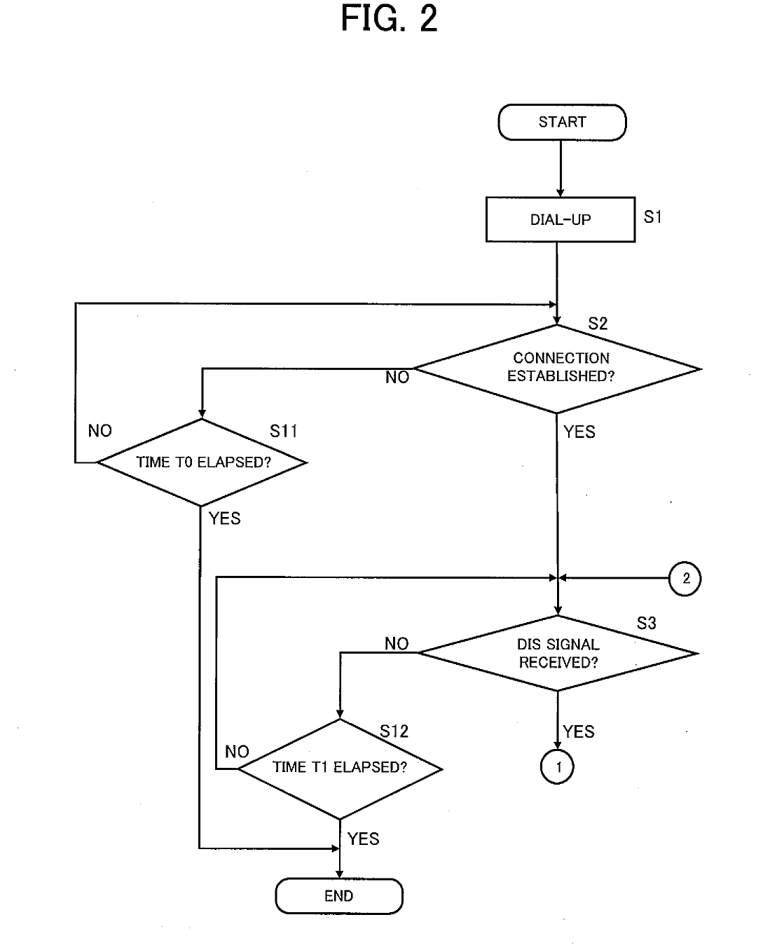

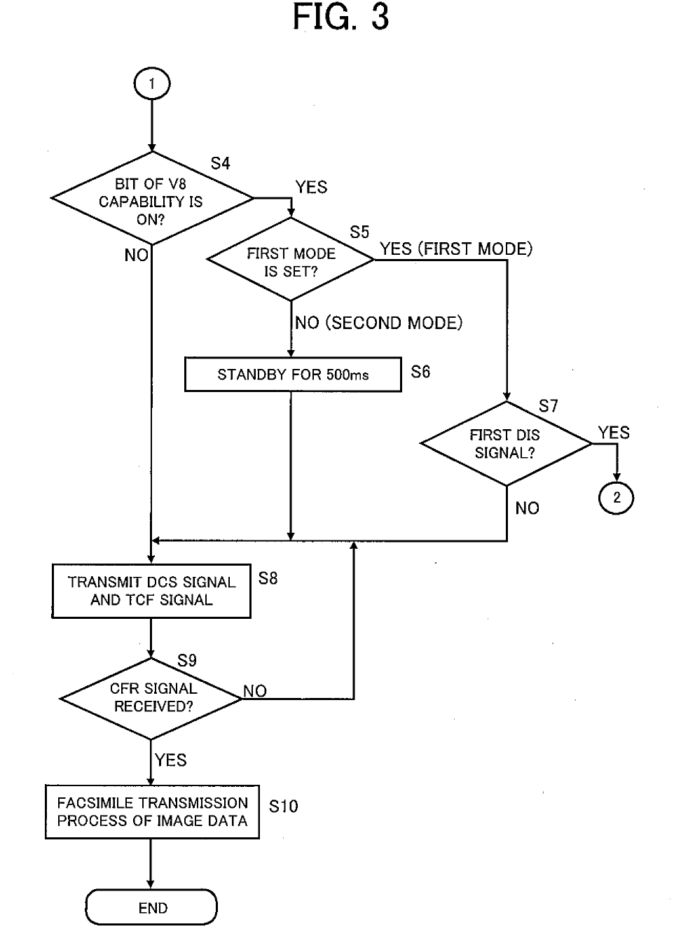

FIGS. 2 and 3 are flowcharts illustrating a procedure by which the communication terminal device (the facsimile machine 20) transmits image data according to an embodiment of the invention.

First, the control unit 1 dials up and makes a call according to an operation performed by the user via the operation unit 5 (entry of a destination facsimile number) (step S1). Then, the control unit 1 detects a presence or an absence of an off-hook of a destination facsimile machine to determine whether or not a connection has been established (step S2). When a connection is not established (step S2: NO), the control unit 1 determines whether or not a prescribed standby time T0 has elapsed (step S11). When the prescribed standby time T0 has not elapsed (step S11: NO), the operation returns to step S2. When the prescribed standby time T0 elapses (step S11: YES), the operation ends.

When a connection is established with the recipient facsimile machine (step S2: YES), the control unit 1 determines whether or not a DIS has been received (step S3). When the DIS has not been received (step S3: NO), the control unit 1 determines whether or not a prescribed standby time T1 has elapsed (step S12). When the prescribed standby time T1 has not elapsed (step S12: NO), the operation returns to step S3. When the prescribed standby time T1 elapses (step S12: YES), the operation ends.

When receiving a DIS from the recipient facsimile machine (step S3: YES), the control unit 1 determines whether or not the BIT of the V.8 capability in the DIS is “1” (step S4). When the BIT is not “1” (step S4: NO), i.e., when the recipient facsimile machine is also a non V.34 terminal, the operation proceeds onto step S8 without executing a special process.

Meanwhile, when the BIT of the V.8 Capability is “1” (step S4: YES), i.e., when the recipient facsimile machine is a V.34 terminal, the control unit 1 determines whether or not the first mode (to standby for a prescribed period of time until responding to the DIS) is set as a response to the V.34 terminal (step S5). When the first mode is set (step 5: YES), the control unit 1 stands by for 500 ms (step S6), and the operation proceeds onto step S8.

When the first mode is not set (step S5: NO), i.e., when the second mode is set (to ignore the first DIS, and standby for a second DIS that arrives three seconds later), the control unit 1 determines whether or not the received DIS is a first DIS (step S7). When the received DIS is the first DIS (step S7: YES), the operation returns to step S3. When the received DIS is not the first DIS (step S7: NO), i.e., when the received DIS is the second DIS, the operation proceeds onto step S8.

The control unit 1 transmits a DCS and a Training Check Function (TCF) (step S8), and determines whether or not a Confirmation to Receive (CFR) has been received (step S9). Further, the CFR is a response signal to the TCF. When the CFR has not been received (step S9: NO), the operation returns to step S8. When the CFR has been received (step S9: YES) the control unit 1 carries out a process of a facsimile transmission for transmitting image data (step S11), and the operation ends.

Under the first mode, it is possible to respond to the DIS after standing by for a shorter period of time compared with the second mode. Thus, in a communication system adopting a time charge system, the first mode is advantageous. Meanwhile, under the second mode, the transmitter communication terminal device responds to the DIS after waiting for three seconds reliably. Thus, it is possible for the echo canceller to reliably return to an ON state.

In the above-described example, the facsimile machine 20 is a non V.34 terminal not including a function of the V.34 communication mode. However, the facsimile machine 20 may be a non V.34 terminal having a function of the V.34 communication mode but incapable of executing the function of the V.34 communication mode due to a setting of the facsimile machine 20. That is, the non V.34 terminal (a communication terminal device incapable of executing the function of the V.34 communication mode, i.e., a communication terminal device incapable of executing the communication function of the V.34 communication mode) may be a communication terminal device, which does not originally include the function of the V.34 communication mode, or a communication terminal device, which includes the function of the V.34 communication mode but cannot execute the function of the V.34 communication mode due to a setting.

While the present invention has been described with respect to embodiments thereof, it will be apparent to those skilled in the art that the invention may be modified in numerous ways and may assume many embodiments other than those specifically set out and described above. Accordingly, the appended claims cover all modifications of the invention that fall within the true spirit and scope of the invention.

What is claimed is:

1. A communication terminal device comprising:
means for detecting a presence or an absence of a capability of an ITU recommendation V.8 communication mode in accordance with a received digital identification signal; and
means for generating a silent state for a prescribed period of time as a response to the received digital identification signal when the means for detecting detects the presence of the capability of the V.8 communication mode.

2. The communication terminal device according to claim 1, further comprising means for setting a silent time lasting for the prescribed period until responding to the received digital identification signal.

3. The communication terminal device according to claim 1, further comprising means for standing by until receiving a next digital identification signal without responding to the digital identification signal received for a first time.

4. The communication terminal device according to claim 1, further comprising means for preventing communication in an ITU recommendation V.34 communication mode from being executed.

5. The communication terminal device according to claim 1, wherein facsimile communication is carried out via an Internet protocol network.

6. The communication terminal device according to claim 1, wherein the prescribed period of time is at least 400 ms.

7. The communication terminal device according to claim 1, wherein the means for detecting detects the presence or absence of the ITU recommendation V.8 communication mode capability by checking a No. 6 BIT of the received digital identification signal.

8. A communication system comprising:
a recipient communication terminal device that can execute communication in an ITU V.34 communication mode, and
a transmitter communication terminal device that cannot execute communication in the ITU V.34 communication mode,
wherein the transmitter communication terminal device comprises:
means for detecting a presence or an absence of a capability of an ITU recommendation V.8 communication mode in accordance with a received digital identification signal; and
means for controlling to generate a silent state for a prescribed period of time as a response to the received digital identification signal when the means for detecting detects the presence of the capability of the V.8 communication mode in the recipient communication terminal device.

9. The communication system according to claim 8, wherein the transmitter communication terminal device further comprises means for standing by until receiving a next digital identification signal without responding to the digital identification signal received for a first time.

10. The communication system according to claim 8, wherein facsimile communication via an Internet protocol network is carried out between the transmitter communication terminal device and the recipient communication terminal device.

11. A facsimile communication method comprising:
making a call to a recipient communication terminal device from a transmitter communication terminal device;
transmitting a digital identification signal by the recipient communication terminal device;
responding to the recipient communication terminal device by the transmitter communication terminal device after a prescribed period of silent time; and
transmitting image data to the recipient communication terminal device from the transmitter communication terminal device.

12. The facsimile communication method according to claim 11, further comprising:
setting the transmitter communication terminal device to not execute a communication of V.34.

13. The facsimile communication method according to claim 11, further comprising:
ignoring a digital identification signal received for a first time from the recipient communication terminal device at the transmitter communication terminal device; and
responding to a digital identification signal received for a second time from the recipient communication terminal device at the transmitter communication terminal device.

14. A facsimile communication method comprising:
receiving a first digital identification signal;
determining a presence or absence of ITU recommendation V.8 communication mode capability in accordance with the first digital identification signal; and
when the ITU V.8 communication mode capability is present, executing either a first mode or a second mode of operation,
wherein the first mode of operation comprises generating a silent state for a prescribed period of time, and
wherein the second mode of operation comprises standing by until a second digital identification signal is received.

15. A method according to claim 14, wherein the presence or absence of the ITU recommendation V.8 communication mode capability is determined by checking a No. 6 BIT of the received digital identification signal.

16. A method according to claim 14, wherein the prescribed period of time is at least 400 ms.

17. A facsimile communication terminal device incapable of communicating in V.34 communication mode, comprising:
a control unit that detects a presence or absence of V.8 communication mode capability in accordance with a received digital identification signal, and that executes either a first mode or a second mode of operation when V.8 communication mode capability is detected,
wherein the first mode of operation comprises generating a silent state for a prescribed period of time, and
wherein the second mode of operation comprises standing by until a second digital identification signal is received.

18. A facsimile communication terminal as claimed in claim 17, wherein:
the controller detects the presence or absence of the V.8 communication mode capability by checking a No. 6 BIT of the received digital identification signal; and
the prescribed period of time is at least 400 ms.

19. A facsimile communication terminal as claimed in claim 17, wherein the terminal is incapable of communicating in a V.34 communication mode because it does not include a function of the V.34 communication mode.

20. A facsimile communication terminal as claimed in claim 17, wherein the terminal includes a function of a V.34 communication mode but is incapable of communicating in the V.34 communication mode due to a setting of the terminal.
